(19) United States
(12) Patent Application Publication
(10) Pub. No.: US 2026/0310932 A1
(43) Pub. Date: Oct. 8, 2026

(54) METHOD FOR GENERATING DATA BASED ON LARGE MODEL, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Jiefan FANG, Beijing (CN); Zhi LI, Beijing (CN); Yiming XU, Beijing (CN); Huanhuan YANG, Beijing (CN); Qiao ZHAO, Beijing (CN)

(73) Assignee: BEIJING BAIDU NETCOM SCIENCE TECHNOLOGY CO., LTD., Beijing (CN)

(21) Appl. No.: 19/684,418

(22) Filed: May 21, 2026

(30) Foreign Application Priority Data
Mar. 20, 2026 (CN) 202610352833.7

(51) Int. Cl. G06N 3/042

(52) U.S. Cl. CPC G06N 3/042

(57) ABSTRACT

Provided is a method for generating data based on large model, an electronic device and a storage medium, relating to technical fields such as large models, data processing, and artificial intelligence. The method includes: inputting target prompt information into a generative large model, so that the generative large model generates question information based on expert knowledge and a target action sequence in the target prompt information, the target action sequence being used to constrain an execution path of the generative large model; the question information includes text data which is a clue required for answering the question information; verifying the question information based on an evaluation large model to obtain a difficulty level that is used to represent a degree of difficulty for the target large model to answer the question information; and constructing a training sample for the target large model based on the question information.

### CROSS-REFERENCE TO RELATED APPLICATIONS

The present application claims priority to Chinese Patent Application No. CN202610352833.7, filed with the China National Intellectual Property Administration on Mar. 20, 2026, the disclosure of which is hereby incorporated herein by reference in its entirety.

### TECHNICAL FIELD

The present disclosure relates to the field of computer technologies, and in particular, to technical fields such as large models, data processing, and artificial intelligence.

### BACKGROUND

With the development and application of artificial intelligence technologies, a large model has demonstrated excellent capabilities in general fields. For example, it has strong capabilities in conventional tasks such as information understanding, content generation, and simple question answering.

However, the large model still has significant limitations when facing complex scenarios. For example, for a complex and difficult question, large model may fail to provide a correct answer.

To improve the processing capability of the large model for difficult questions, training samples can currently be constructed to train the large model. However, the construction process of current training data for large model capabilities mostly relies excessively on expert experience and manual iteration. The construction process of training data is highly subjective and difficult to be reused on a large scale.

### SUMMARY

The present disclosure provides a method and apparatus for generating data based on large model, a device and a storage medium.

In a first aspect, the present disclosure provides a method for generating data based on large model, including:

inputting target prompt information into a generative large model, such that the generative large model generates first question information based on expert knowledge and a target action sequence in the target prompt information, wherein the target action sequence is configured to constrain an execution path of the generative large model; the first question information includes text data, and the text data is a clue required for answering the first question information;

verifying the first question information based on an evaluation large model to obtain a difficulty level, wherein the difficulty level is used to represent a degree of difficulty for the target large model to answer the first question information; and

constructing a training sample for the target large model based on the first question information in the case where the difficulty level is a target level.

In a second aspect, the present disclosure provides an apparatus for generating data based on large model, including:

a generation module, configured to input target prompt information into a generative large model, such that the generative large model generates first question information based on expert knowledge and a target action sequence in the target prompt information, wherein the target action sequence is configured to constrain an execution path of the generative large model; the first question information includes text data, and the text data is a clue required for answering the first question information;

a verification module, configured to verify the first question information based on an evaluation large model to obtain a difficulty level, wherein the difficulty level is used to represent a degree of difficulty for the target large model to answer the first question information; and

a first construction module, configured to construct a training sample for the target large model based on the first question information in the case where the difficulty level is a target level.

In a third aspect, the present disclosure provides an electronic device, including:

at least one processor; and

a memory connected in communication with the at least one processor;

where the memory stores an instruction executable by the at least one processor, and the instruction, when executed by the at least one processor, enables the at least one processor to execute the method of any embodiment of the present disclosure.

In a fourth aspect, the present disclosure provides a non-transitory computer-readable storage medium storing a computer instruction thereon, and the computer instruction is used to cause a computer to execute the method of any embodiment of the present disclosure.

In a fifth aspect, the present disclosure provides a computer program product including a computer program that, when executed by a processor, implements the method according to any embodiment of the present disclosure is provided.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are included to provide a better understanding of the present solution and are not to be construed as limiting the present disclosure. In the drawings:

FIG. 1 is a schematic flowchart of a method for generating data based on large model according to an embodiment of the present disclosure;

FIG. 2 is a schematic flowchart of generating first question information according to an embodiment of the present disclosure;

FIG. 3 is a schematic flowchart of verifying the first question information based on an evaluation large model to obtain a difficulty level according to another embodiment of the present disclosure;

FIG. 4 is a schematic flowchart of cracking the first question information based on a first intelligence agent in the evaluation large model to obtain a cracking result according to an embodiment of the present disclosure;

FIG. 5 is a schematic flowchart of obtaining the difficulty level of the first question information output from a second intelligence agent according to an embodiment of the present disclosure;

FIG. 6 is a schematic flowchart of training and optimizing a target large model according to an embodiment of the present disclosure;

FIG. 7 is a schematic flowchart of constructing third question information according to an embodiment of the present disclosure;

FIG. 8 is schematic block diagram of an apparatus for generating data based on a large model according to an embodiment of the present disclosure;

FIG. 9 is a schematic block diagram of an apparatus for generating data based on a large model according to another embodiment of the present disclosure;

FIG. 10 is a block diagram of an electronic device for implementing the method for generating data based on a large model according to the embodiment of the present disclosure.

### DETAILED DESCRIPTION

Exemplary embodiments of the present disclosure are described below with reference to the accompanying drawings, in which various details of embodiments of the present disclosure are included to assist understanding, and which are to be considered as merely exemplary. It should therefore be understood that those skilled in the art may make various changes and modifications to the described embodiments without departing from the scope of the present disclosure. Likewise, for the sake of clarity and conciseness, well-known functions and structures are not described in detail herein.

The terms “first”, “second” and the like in the present disclosure are used to distinguish similar objects and are not necessarily used to describe a specific order or sequence. In addition, the terms “comprise” and “have” and any variations thereof are intended to cover non-exclusive inclusion, for example, inclusion of a series of steps or units. A method, system, product, or device is not necessarily limited to those steps or units explicitly listed, but may include other steps or units not explicitly listed or inherent to the process, method, product, or device.

It should be noted that the operations shown in the flowcharts in the embodiments of the present disclosure can be executed in any order or simultaneously unless it is explicitly stated that there is an execution sequence between different operations or there is an execution sequence in technical implementation between different operations.

For sake of understanding, some key terms involved in the present disclosure are explained below, in which:

Difficult data, also referred to as high-difficulty data, mainly refers to questions that are difficult for a large model to process in the present disclosure. Difficulty in processing can be understood as that the large model is difficult to provide stable correct answers or often times out in inference, and can be characterized by at least one of multiple searches, multiple inferences, or cross-verification;

Question sample, as the name implies, is used to describe a difficult question and belongs to the category of difficult data. The question sample is mainly used to train and optimize the large model, so that the large model can learn the inference mode of difficult data and infer stable correct answers;

Expert knowledge, i.e., knowledge obtained by a professional (i.e., an expert) through analyzing and summarizing difficult data. In the embodiments of the present disclosure, the expert knowledge can be standardized and converted into instructions or indications or prior indications understandable by the large model, so that the expert knowledge can be used as input information of a generative large model to constrain the process of generating question samples by the generative large model;

Clue, answer clue, or to-be-processed clue in the embodiments of the present disclosure all refer to contents contained in difficult data or question samples, and the clue is used to provide known information required for answering a question for the large model to infer an answer by analyzing the clue;

The generative large model in the embodiments of the present disclosure refers to a large model for generating content; the evaluation large model refers to a large model for evaluating the difficulty level of difficult data; the target large model refers to a large model for answering difficult data; a topological graph generative large model refers to a large model for generating a topological graph; a first verification large model and a second verification large model refer to large models for completing corresponding verification tasks. The large model can be set as an LLM (Large Language Model) or an MLLM (Multimodal Large Language Model) according to task requirements. The MLLM is a large-scale artificial intelligence model capable of simultaneously understanding, processing, and generating multiple types of information, realizing cross-modal information alignment, association, and inference through a unified semantic space, and thus completing complex perception and cognitive tasks that cannot be realized by traditional single-modal models.

In the related art, training samples for difficult data are all conceived and prepared manually. Since different individuals have different knowledge reserves, the construction efficiency of training samples is low and the quality is difficult to ensure. Overall, such a technical approach relies heavily on human experience and manual iteration, the construction process is highly subjective, exhibits prominent case-specific features, and fails to form a unified paradigm.

In view of this, an embodiment of the present disclosure provides a method for generating data based on large model, which is used to overcome the defects in the related art that rely on manual experience, are highly subjective, lack quantitative standards, and are difficult to construct training data in a large-scale and standardized manner.

The method can be implemented by one computing device or with the assistance of multiple computing devices. When implemented by one computing device, the large model involved in the embodiments of the present disclosure runs in the one computing device. When implemented with the assistance of multiple computing devices, the large model involved in the embodiments of the present disclosure is installed in the multiple computing devices. It can be understood that the large model designed in the embodiments of the present disclosure can be one large model playing different roles or different large models playing different roles. This is not limited by the embodiments of the present disclosure and can be set according to actual requirements.

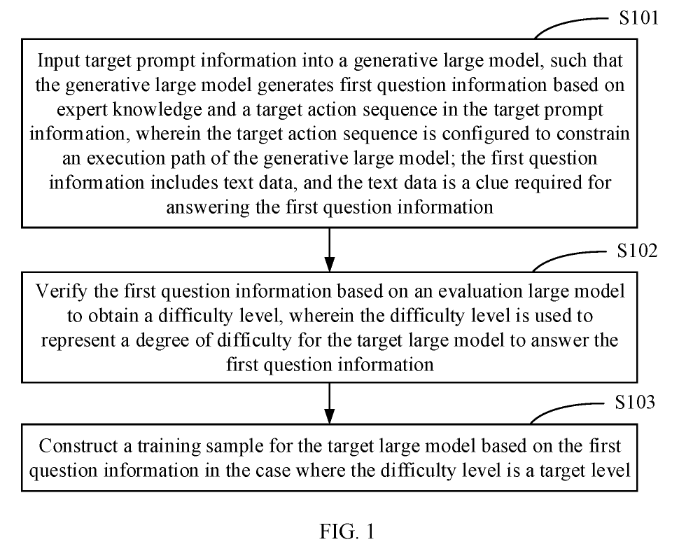

As shown, FIG. 1 is a schematic flowchart of a method for generating data based on a large model according to an embodiment of the present disclosure, including the following contents:

S101: inputting target prompt information into a generative large model, such that the generative large model generates first question information based on expert knowledge and a target action sequence in the target prompt information, wherein the target action sequence is configured to constrain an execution path of the generative large model; the first question information includes text data, and the text data is a clue required for answering the first question information.

The target prompt information can be understood as a standardized generation instruction set input to the generative large model, and is structured information (which can include text information or graphic and text information) integrated with the expert knowledge, the target action sequence and basic constraints for data generation. The expert knowledge and the target action sequence generate training requirements conforming to difficult data for the generative large model and provide full-dimensional generation guidance and execution constraints, improving the quality of the first question information generated by the generative large model to meet high-difficulty, standardized and verifiable requirements.

Herein, the expert knowledge includes a series of difficult question tags and construction descriptions of the tags. The construction description is a definition of the tag and a requirement and precaution when constructing the difficult data. For example, when a person or an event is taken as a target answer, the expert knowledge includes but is not limited to the following difficult question tags and corresponding construction rules:

Intervalization: constructing a specific numerical value into a numerical interval;

Geometric constraint: constructing a position into a position relative relationship;

Content masking: concealing a name of a narrative carrier by describing a content plot and the like;

Semantic relationship/attribute masking: avoiding direct mention of a core entity by introducing an associated entity or sub-attribute to increase search chains and links;

Rough biography: requiring a vague character biography involving birth, occupation, works, general experience and time thereof, wherein each constraint is extremely weak, and there are still a number of candidates after single screening;

Vague summary: giving a vague full description of an event involving time, place, participant(s), a result, etc., wherein each constraint is extremely weak, and there are still a number of candidates after single screening;

Forward anchoring: used to explicitly give a set to which an entity belongs: such as a member of xxx, attending a meeting..., wherein the entity must be an element in the given set;

Negative exclusion: used to give a set to which an entity does not belong, forcing the model to first forward search the complete set and then verify whether a candidate meets the constraint;

Trivial collection: used to extract trivial details in information and present them in the form of a “highlight collection”;

Anonymous dashboard: used to give a number of parameters, statistical values and summary information about entity details, similar to an unnamed summary dashboard;

Old version snapshot: used to give intermediate version values for frequently iterated data, making the reference information volume exploded;

Attribute co-channel: used to make entities have similar attributes and realize multiple anonymization of multiple entities with common features;

Rootless sorting: determining the identity of a target entity by its relative order in a sequence, with unknown reference point (predecessor or successor) of the sequence.

In an implementation, the construction rule corresponding to the difficult question tag can be converted into a form such as a rule description, a constraint condition, a generation requirement or an example expression, and used as internal knowledge of a prompt to guide a generative large model to generate question information meeting requirements according to the rule defined by expert knowledge.

The target action sequence is a standardized step-by-step operation instruction in target prompt information for constraining an execution path of the generative large model, and is a set of action steps that convert the expert knowledge into executable and progressively fixed logic for the generative large model.

The first question information includes text data, which is not limited to a pure text form and can further include visual content such as an image and a chart to form a clue form combining graphics and text, wherein the text part is used to provide text clues such as semantic description, condition constraint, and inference prompt, and the image or chart part is used to provide visual clues such as a graphic feature, a position relationship, a numerical distribution and a structural schematic, which together form a complete clue set required for answering the first question information.

A guidance large model in the embodiment of the present disclosure mainly means that a large model executes an inference process depending on target prompt information, and the inference process meets a requirement of the target prompt information.

S102: verifying the first question information based on an evaluation large model to obtain a difficulty level, wherein the difficulty level is used to represent a degree of difficulty for the target large model to answer the first question information.

The evaluation large model is a large model for quality acceptance of the generated first question information. Verified quality indicators can include at least one of search difficulty and inference difficulty.

The search difficulty can be understood as covering at least one of core search capabilities such as cross-domain retrieval, multi-hop inference, real-time information verification, or long text integration. Herein:

Cross-domain retrieval means that a large model can simultaneously search for and integrate information from different types and different fields of information sources. For example, in one query, it can integrate contents from various sources such as news websites, academic papers, encyclopedia entries, social media, and enterprise databases to provide a comprehensive and multi-dimensional answer instead of simply listing a single source.

Multi-hop inference means that a large model has the ability to continuously think and ask questions through multiple logical steps; when a user’s question cannot be directly answered through a single retrieval, the model can, like a “detective”, put forward a new sub-question according to the obtained information, perform the next round of retrieval, and finally connect all clues to infer the answer to a complex question. For example, answering “What is the product of the first company founded by Zhang San?” requires first retrieving “The first company founded by Zhang San is AA”, and then retrieving “What does AA do”.

Real-time information verification means that a large model can obtain and use the latest information to verify or update contents in its knowledge base; this usually relies on a networked search function. When asking about dynamic information such as current events, stock prices, and sports event results, the model can actively search for the up-to-date information to ensure that the provided answer is not based on outdated training data, thereby ensuring the timeliness and accuracy of the information.

Long text integration means that a large model can effectively process, understand, and summarize ultra-long documents or information. When a user uploads a long report, an e-book, or requests analysis of multiple lengthy webpage contents, the model can overcome the limitation of context length, accurately capture the core arguments, key data, and logical context of the full text, and generate a refined abstract, answer detailed questions based on the full text, or perform cross-document information comparison and synthesis.

The above search capabilities work together to make the large model no longer a simple information retrieval tool, but an intelligent research assistant capable of deeply understanding questions, actively exploring information, and conducting comprehensive analysis and presentation.

Inference difficulty in the embodiments of the present disclosure can be understood as the complexity of internal logical processing and thinking chain construction required for the large model to answer a question. The inference difficulty mainly depends on:

Depth and structure of logical chain: that is, the more the continuous and coherent logical inference steps (“hop count”) required to answer a question and the more the complex structures such as dependency, bifurcation or backtracking between steps, the higher the difficulty.

Dependency on implicit knowledge and abstract concepts: surface information failing to directly answer a question, and for inference, analogy or abstract generalization, needing to invoke common sense, rules and principles that are not explicitly stated.

In short, the inference difficulty measures the depth of “thinking” of the large model rather than the breadth of “searching”. For a high-inference-difficulty question, even if all necessary information is directly provided to the model, it may still fail due to inability to perform correct multi-step logical deduction.

The difficulty level in the embodiments of the present disclosure is an evaluation index for quantifying the solution of the first question information, and can be divided into levels according to actual training requirements, for example, divided into four levels: easy, medium, difficult, and extremely difficult.

In an implementation, the generated first question information can be input into an evaluation large model, and a difficulty level corresponding to the first question information can be obtained through comprehensive analysis of dimensions, such as the number of inference steps, knowledge point span, inference chain length and the number of distractors, required for the evaluation large model to simulate the target large model processing the first question information.

S103: constructing a training sample for the target large model based on the first question information in the case where the difficulty level is a target level.

The target level is a preset difficulty threshold meeting a training requirement of the target large model. When the output difficulty level is the target level, the first question information can be determined as valid difficult data; otherwise, it is determined as invalid difficult data.

In an implementation, for the first question information serving as the valid difficult data, the training sample meeting a training format requirement of the target large model can be constructed according to the format requirement.

In the embodiment of the present disclosure, the target prompt information is input into the generative large model, so that the generative large model generates the first question information based on the expert knowledge and the target action sequence constraining the execution path in the target prompt information. The expert knowledge and the target action sequence can standardize the question generation logic of the generative large model, generate difficult data based on the unified knowledge reserve and cognition of the generative large model itself, ensure question quality from the source, and get rid of the construction mode dominated by manual experience. In addition, in the embodiment of the present disclosure, verifying the first question information based on the evaluation large model to obtain the difficulty level can objectively quantify question solution difficulty, realize standardized judgment of difficulty stratification, replace manual qualitative judgment, effectively avoid problems such as constraint redundancy and large quality fluctuation, and greatly improve the stability and standardization level of data set construction. Constructing the training sample based on the first question information when the difficulty level meets the target level can accurately match the training requirement of the target large model and screen high-quality difficult data with strong adaptability. Therefore, a unified technical paradigm that allows copy and cross-field migration is formed through the mode of generation plus difficulty evaluation. A new scenario can be quickly adapted only by adjusting prompt information and constraint rules without rebuilding field logic, which can solve the pain points of low reuse rate and difficult cross-field implementation of traditional solutions.

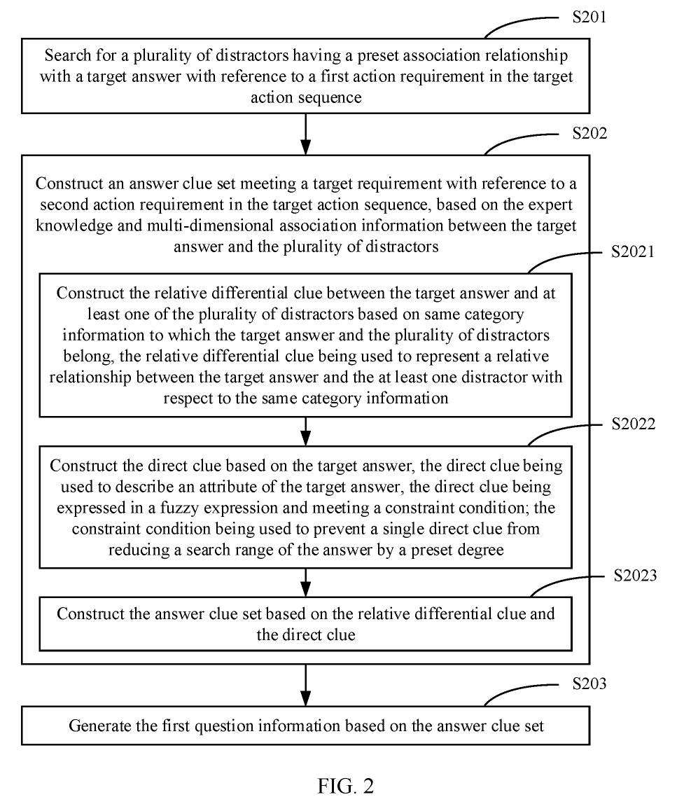

In the embodiment of the present disclosure, the target prompt information is input into the generative large model, such that the generative large model generates the first question information based on the expert knowledge and the target action sequence in the target prompt information. The generative large model can perform the operations as shown in FIG. 2 under the guidance of the target action sequence of the target prompt information to generate the first question information:

S201: searching for a plurality of distractors having a preset association relationship with a target answer with reference to a first action requirement in the target action sequence.

The first action requirement is to find a plurality of distractors.

Herein, the expert knowledge includes the preset association relationship. For different question fields, the preset association relationship is used to express a specific category of information association that should be satisfied between a target answer and a distractor. The specific category is determined based on the question field, and is a same-type attribute relationship shared by the target answer and the distractor, ensuring that the distractor and the target answer belong to the same dimension, same attribute, and same logic type, such that the distractor has targeted interference with the target answer to improve the construction success rate of training samples.

In an implementation, the plurality of distractors having the preset association relationship with the target answer can be searched based on the following steps:

Step A1: determining a target field to which the target answer belongs;

The target field is a question field to which a target answer belongs. For example, asking about films, stars, and ancient celebrities can belong to different question fields.

In an implementation, field recognition can be performed on the target answer based on the large model, and the technical field or the business field to which the target answer belongs can be determined according to a preset field classification system. For example, specific fields such as film/animation, music, history/politics, science, sports and games.

In addition, a corresponding relationship between an entity word and a question field can be constructed to facilitate determining the target field of the target answer by querying the corresponding relationship.

Step A2: obtaining entity information associated with the target answer based on the preset association relationship corresponding to the target field;

In an implementation, after determining the target field to which the target answer belongs, entity information of specific categories having a direct or indirect logical association with the target answer can be automatically searched for and extracted starting from the target answer according to a pre-defined entity association rule of the field.

Exemplarily, when the target answer is “Song A”, a preset association relationship pre-configured in the music field can include: song-release company association, song-MV (Music Video) director association, song-singing band association, song-album association, etc. Herein, the release company, MV director, singing band, and album all belong to entity information of specific categories corresponding to the target answer. It can be understood that a specific category in a question field can include multiple entities for constructing difficult data of multi-dimensional clues.

Step A3: searching for a plurality of similar entities whose similarity with the entity information meets a similarity requirement to obtain a plurality of candidate items;

In an implementation, other entities with the same type and similar attributes can be retrieved in the knowledge base or data set based on acquired entity information according to a preset similarity calculation rule, and similar entities whose similarity meets requirements can be screened out as the candidate items for subsequent question construction.

Exemplarily, the target answer is “Song A”, and candidate items include “Song B” and “Song C”. “Song A” and “Song B” may be similar in entity information such as release time and release company.

Step A4: constructing a general reference clue for the plurality of candidate items and the target answer;

The general reference clue refers to a clue adapted to both the target answer and all the candidate items, and the target answer and candidate items cannot be directly distinguished through a single or a few clues.

In an implementation, common attribute, logic, semantic, feature and other dimensional information of the plurality of obtained candidate items and the target answer can be extracted to construct the general reference clue.

Step A5: filtering out candidate items that distinguish the target answer from the candidate items by relying on at most a preset number of reference clues, and taking the remaining candidate items as distractors.

The preset number is defined by a question field and a required difficulty level of difficult question in the expert knowledge, and is a core threshold for distinguishing valid distractors from invalid distractors. Generally, a distractor that can significantly reduce a search range with a small number of reference clues (e.g., a ratio before and after the search range is reduced exceeds a ratio threshold) is an invalid distractor, because significantly reducing the search range will reduce the problem-answering difficulty of the target large model.

In an implementation, the candidate items can be detected one by one based on the preset number to judge whether the target answer can be accurately distinguished from the candidate items only by relying on at most the preset number of reference clues. The candidate items meeting the preset number are directly eliminated, the candidate items that cannot quickly reduce search difficulty and/or inference difficulty through a small number of reference clues are retained, and finally the remaining candidate items are taken as a plurality of qualified distractors to complete a distractor screening process. Herein, the quick reduction can be understood as that the rate of corresponding difficulty reduction is higher than a rate threshold.

In the embodiment of the present disclosure, by screening out the distractors that are highly similar to the target answer and can only be distinguished through multi-clue cross-verification, it is possible to establish a high-matching comparison reference for subsequent construction of answer clues, avoid the single-point explosion problem that an answer can be locked based on a small number of clues, and finally lay a key foundation for generating the first question information with high-difficulty search inference attributes, thereby improving the difficulty quality of training samples.

S202: constructing an answer clue set meeting a target requirement with reference to a second action requirement in the target action sequence, based on the expert knowledge and multi-dimensional association information between the target answer and the plurality of distractors.

Herein the second action requirement is used to describe mode and method constraints for generating the first question information, including the target requirement, for example. The target requirement in the expert knowledge includes a requirement for a relative differential clue and a direct clue.

In an implementation, as shown in FIG. 2, constructing the answer clue set meeting the target requirement based on the expert knowledge and the multi-dimensional association information between the target answer and the plurality of distractors may be implemented based on the following steps:

Step S2021: constructing the relative differential clue between the target answer and at least one of the plurality of distractors based on same category information to which the target answer and the plurality of distractors belong, the relative differential clue being used to represent a relative relationship between the target answer and the at least one distractor with respect to the same category information.

The same category information refers to common feature information between the target answer and the plurality of distractors that can be compared in the same label dimension, and can be used to describe a relative relationship therebetween. For example, an age gap between two directors and a relative distance between two locations both describe relative relationships. It can be understood that these relative relationships can be refined and described for different question fields, which is not limited in the present disclosure.

In an implementation, the same category information commonly attributed to the target answer and the plurality of distractors may be extracted first, and based on the same category information, differentiated association features between the target answer and a single distractor are analyzed one by one, a comparison relationship and relative difference points therebetween are extracted, and the relative differential clue is generated.

Exemplarily, common sources of the relative differential clues include: age difference, time difference, sequence relationship, same-city/same-school/same-period/classmate relationship, institution establishment time difference, and other verifiable same or corresponding relationships.

Step S2022: constructing the direct clue based on the target answer, the direct clue being used to describe an attribute of the target answer, the direct clue being expressed in a fuzzy expression and meeting a constraint condition; the constraint condition being used to prevent a single direct clue from reducing a search range of the answer by a preset degree.

The fuzzy expression means that the direct clue is not directly and explicitly expressed, but is inferred by using other clues, or pointed to by giving a range. For the latter, for example, when indicating the birth year of a celebrity, a year is not given directly but a year range is given.

In an implementation, the direct clue may be constructed based on the own attribute of the target answer in combination with expression specifications in the expert knowledge, while strictly meeting preset constraint conditions to realize the fuzzy expression.

Exemplarily, any direct naming clues such as specific person names, place names, specific dates, specific award names, institutions, work names, and competition names are avoided in the constructed direct clues, and clues with high identifiability such as “the most common”, “the most iconic” and “the most famous” for the target answer are all regarded as direct clues.

Step S2023: constructing the answer clue set based on the relative differential clue and the direct clue.

In an implementation, the generative large model may summarize and sort out the relative differential clue and the direct clue, remove redundant, repeated and conflicting clue contents, confirm the importance and logical priority of the clues, and sort and arrange the clues according to the logical priority of answering the question, so as to form a complete, smooth, concise, non-redundant and unambiguous answer clue set.

In the embodiment of the present disclosure, the relative differential clue is taken as the main body to fundamentally avoid the single-point explosion problem, and the direct clue having low-saliency is supplemented to enrich the clue dimensions without reducing the question difficulty. Meanwhile, the clue construction is closely combined with the association information between the target answer and the distractors, so that the formed answer clue set can be answered necessarily through multi-clue cross-verification, thereby improving the difficulty level of the training sample and the quality of the generated training sample.

Based on the content as described above, the direct clue is a clue describing the own attribute of the target answer, and is prone to high-identifiability information, causing the model to lock the answer only with a few direct clues; while the relative differential clue is constructed based on the same category information of the target answer and the distractors, only reflecting the relative relationship, and different relative differential clues can form cross-verification, which can effectively guide the model to perform multi-dimensional retrieval and inference. Therefore, when constructing the answer clue set based on the relative differential clue and the direct clue, the target requirement includes that the number of the relative differential clues is higher than that of the direct clues, and a proportion of the relative differential clues in the answer clue set is higher than a preset proportion.

In the embodiment of the present disclosure, by requiring that the number of relative differential clues in the answer clue set is more than that of direct clues and the proportion exceeds the preset proportion, it is possible to strengthen the dominant position of the relative differential clues with quantity and proportion constraints, fully exert their attributes of non-single-point explosion and requiring multi-dimensional cross-verification, and avoid the risk that the first question information is reduced in difficulty and easily cracked by the target model due to excessive identifiability of the direct clues, thereby improving the difficulty level of the training sample and the construction quality of the training sample.

S203: generating the first question information based on the answer clue set.

In an implementation, the generative large model integrates, polishes and coherently processes the originally scattered and independent multiple answer clues based on the constructed answer clue set according to a natural and smooth expression logic and in combination with the rule and structure requirement specified by the expert knowledge, so as to form a complete, smooth question description conforming to the difficult question construction standard, which is taken as the first question information.

In the embodiment of the present disclosure, under the guidance of the target action sequence, highly confusing distractors are first matched for the target answer, and then an answer clue set with no shortcuts for the target large model to answer and meeting the high-difficulty inference requirement is constructed in combination with the expert knowledge and the multi-dimensional association information between the target answer and the distractors. Finally, the first question information is integrated and generated based on the clue set, which can prevent the generative large model from quickly obtaining an answer through simple clues and improve the quality and difficulty of the training sample.

In addition to the expert knowledge as described above, the expert knowledge in the embodiment of the present disclosure may further include:

a target answer of the generated first question information being unique, and at least one clue in the first question information being a verifiable fact.

Herein, the target answer being unique means that the first question information has only one definite, unambiguous standard answer that will not produce multiple reasonable solutions.

At least one clue in the first question information is a true fact and can be externally verified, that is, the clue content conforms to objective reality and can be verified through searching and consulting materials or authoritative channels, rather than being fictional or subjective. Based on the requirement of verifiable uniqueness, the generative large model verifies whether the generated result is unique during the generation of the first question information. For example, all results matching the first question information are determined through searching and querying materials and inference, and the uniqueness is met if a unique result can be obtained. For another example, the clues therein are searched for materials with high confidence for verification to determine whether the at least one clue is a verifiable fact.

In the embodiment of the present disclosure, by explicitly requiring in the expert knowledge that the target answer of the generated first question information is unique and contains at least one true and verifiable clue, it can be ensured that the generated first question information has stable, reliable and verifiable basic attributes, avoiding the situations of non-unique answers, false clues or unverifiable clues, thereby improving the quality of the training sample.

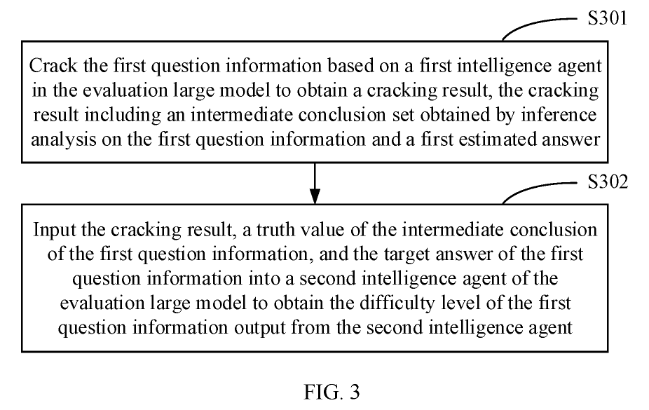

Based on the contents as described above, the first question information is generated based on the answer clue set, and the answer clue set is constructed based on the relative differential clue and the direct clue. Therefore, a to-be-processed clue may be a clue completely consistent with a single answer clue in the answer clue set, directly using the original expression of the single answer clue. It may also be a clue obtained by converting the expression mode and coherently reconstructing the semantics of the answer clue due to the integration and processing during the generation of the first question information. For example, the scattered relative differential clue and direct clue are fused into a coherent implicit description statement, or the original expression of the clue is synonymously replaced and fuzzily rewritten. Therefore, the content corresponding to the answer clue in the first question information can be referred to as the to-be-processed clue. In the embodiment of the present disclosure, the first question information is verified based on the evaluation large model to obtain the difficulty level, so as to screen information with a required difficulty to construct a training sample. As shown in FIG. 3, the following contents are included:

S301: cracking the first question information based on a first intelligence agent in the evaluation large model to obtain a cracking result, the cracking result including an intermediate conclusion set obtained by inference analysis on the first question information and a first estimated answer.

In an implementation, the first intelligence agent can simulate a real problem-answering state of the target large model, perform inference analysis based on the to-be-processed clue in the first question information, completely reproduce the whole process of inference, analysis and guess answering, and finally output the cracking result including the intermediate conclusion set and the first estimated answer.

In addition, the first intelligence agent can also associate the to-be-processed clue indicated in the first question information only relying on its own pre-trained internalized knowledge without relying on any external search tools, so as to obtain the cracking result. That is, the cracking result is obtained by blind guessing through knowledge association of the to-be-processed clues.

Herein the intermediate conclusion set refers to a phased inference result made by the first intelligence agent for the to-be-processed clue during the inference process, such as the basis for the next inference.

The first estimated answer is a candidate answer finally derived by the first intelligence agent based on all intermediate conclusions, which may be a unique answer, multiple candidate answers or no valid answer.

S302: inputting the cracking result, a truth value of the intermediate conclusion of the first question information, and the target answer of the first question information into a second intelligence agent of the evaluation large model to obtain the difficulty level of the first question information output from the second intelligence agent.

The truth value of intermediate conclusions is a phased correct inference result corresponding to the answer clue set of the first question information, and is an important basis for verifying whether the inference process of the first intelligence agent is available and correct. The large model may first generate a knowledge graph structure corresponding to the first question information, screen out a plurality of indispensable intermediate conclusions therefrom, and construct the truth value of intermediate conclusion of the first question information. The generated knowledge graph structure may also be output and displayed and a plurality of indispensable intermediate conclusions may be manually labeled by a labeling expert, so as to obtain the truth value of intermediate conclusion.

It should be noted that the truth value of intermediate conclusion needs to comply with at least one of the following requirements:
(1) Format specification: A granularity of the intermediate conclusion is judged according to the condition and the single search volume. Generally, one intermediate conclusion corresponds to “single condition + single search information volume”, and each to-be-processed clue must be accompanied by a subject to ensure the integrity of the subject, predicate and object.
(2) Obtained by search: The intermediate conclusions are all necessary information in the process of obtaining the target answer and can only be obtained through search, rather than the content directly given in the first question information.
(3) Answer-related: When the single condition has a large range and points to many entities, the intermediate conclusion may only present the part related to the target answer.

In an implementation, the above requirements may be constructed into a prompt for the large model to screen out required intermediate conclusions from the knowledge graph structure and construct the truth value of intermediate conclusion.

In the embodiment of the present disclosure, the first intelligence agent cracks the first question information, so as to obtain the cracking result including the intermediate conclusion and the estimated answer. Subsequently, the second intelligence agent combines the truth value of intermediate conclusion and the target answer of the first question information for comprehensive judgment and output of the difficulty level, which can analyze the corresponding difficulty level, thereby improving the construction quality of difficult data. Moreover, the evaluation operation process can be reproduced, which helps to construct a standardized difficult data generation process.

The first intelligence agent and the second intelligence agent in the embodiment of the present disclosure may also be implemented by large models, which may be the same large model or different large models, the difference of which resides in different types of tasks being performed.

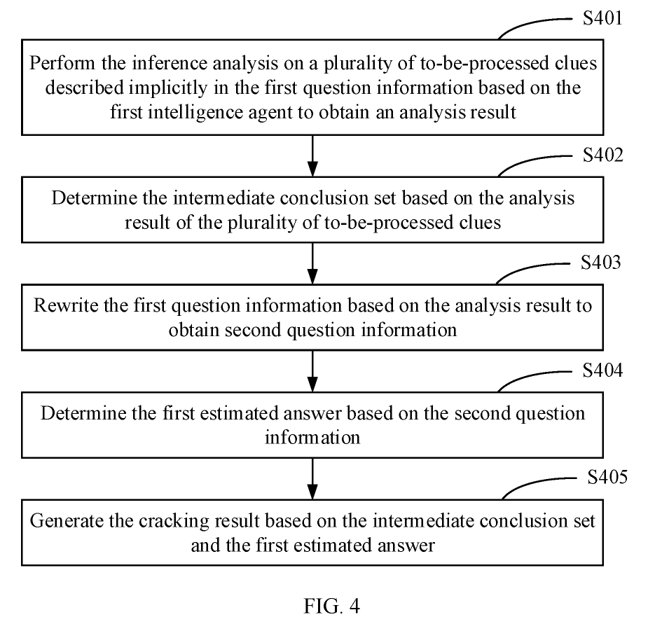

In the embodiment of the present disclosure, when the first intelligence agent answers the question by blind guessing, the above-mentioned Step S301 of cracking the first question information based on the first intelligence agent in the evaluation large model to obtain the cracking result, as shown in FIG. 4, may include the following contents:

S401: performing the inference analysis on a plurality of to-be-processed clues described implicitly in the first question information based on the first intelligence agent to obtain an analysis result.

In an implementation, a first evaluation prompt may be constructed and input into the first intelligence agent, so that the first intelligence agent performs the inference analysis on the plurality of to-be-processed clues in the first question information with reference to at least one of the following constraint conditions in the first evaluation prompt to obtain the analysis result:

Constraint Condition 1: performing knowledge inference on a single to-be-processed clue based on the first intelligence agent to determine a knowledge entity corresponding to the single to-be-processed clue;

That is, the first intelligence agent analyzes the to-be-processed clue separately, interprets, matches and deduces the implicit description in the to-be-processed clue based on a pre-trained knowledge base, and retrieves and determines the knowledge entity equivalent to the single to-be-processed clue. It can also be understood as the conclusion directly pointed to on the clue.

Constraint Condition 2: performing knowledge inference based on context information in the first question information to obtain a knowledge entity inferred from the plurality of to-be-processed clues;

That is, in the case where the semantics of a single clue is incomplete and cannot be independently inferred, the first intelligence agent may associate and aggregate the plurality of fragmented to-be-processed clues in combination with context information such as the context of the first question information, the logic of preceding and following sentences and the association relationship between the clues, so as to obtain the knowledge entity inferred from the plurality of to-be-processed clues.

Constraint Condition 3: retaining at least one to-be-processed clue unchanged in the case where the at least one to-be-processed clue meets a preset feature, the preset feature being used to represent that the at least one to-be-processed clue cannot be cracked;

That is, at least one associated to-be-processed clue is aggregated into a clue subset. In the case where an implicit degree of the description of the clue subset is too high (e.g., an estimated value of the implicit degree is higher than a preset implicit degree), or a large number of long-tail details are involved (e.g., a large number of long-tail details included therein are determined by classifying the clue subset), resulting in that the first intelligence agent has no knowledge base association and cannot perform blind guessing and cracking only by its own knowledge, it is determined that the clue subset meets the preset feature.

In an implementation, for the to-be-processed clue meeting the preset feature, no entity matching and derivation operations are performed, and the original implicit expression of the clue is directly retained. In addition, the reason for retention may be indicated in the cracking result at the same time.

In summary, the first intelligence agent performs inference analysis on the plurality of to-be-processed clues described implicitly in the first question information, and the obtained analysis result may include an independent knowledge entity corresponding to a single to-be-processed clue, an associated knowledge entity obtained by aggregation inference of the plurality of to-be-processed clues, an uncracked implicit clue meeting the preset feature, a retention reason, an inference basis and other contents.

In the embodiment of the present disclosure, the single-clue independent inference and multi-clue context linkage inference constraint conditions in the first evaluation prompt enable the first intelligence agent to deeply dig the knowledge entity behind the implicit clue and accurately restore an actual direction of the clue. The constraint condition of retaining the original state of the uncrackable clue in the first evaluation prompt can avoid distortion of the cracking result caused by excessive inference, enable the inference analysis result to completely present the crackable information of the clue, ensure that the final cracking result can truly reflect the actual inference difficulty of the first question information, so as to improve the accuracy of evaluating the difficulty level and thus the quality of the training sample.

S402: determining the intermediate conclusion set based on the analysis result of the plurality of to-be-processed clues.

In an implementation, the knowledge entity obtained by the inference analysis may be taken as an intermediate conclusion to construct the intermediate conclusion set.

That is, the knowledge entity obtained by the inference analysis is integrated according to a clue correspondence to obtain the intermediate conclusion set, which completely restores the whole inference process from clue disassembly to gradually approaching the answer. Specifically, a dependency relationship between knowledge entities may be constructed to obtain a knowledge graph.

In the embodiment of the present disclosure, the knowledge entity inferred and analyzed by the first intelligence agent from the to-be-processed clue is directly taken as an intermediate conclusion to construct the intermediate conclusion set, which can structurally integrate scattered inference results to form a standardized intermediate conclusion set that can be verified, traced, and used for subsequent question rewriting and answer estimation, providing a stable basis for evaluating the difficulty of the first question information and verifying the correctness of model inference, thereby improving the accuracy of difficulty level prediction.

S403: rewriting the first question information based on the analysis result to obtain second question information.

In an implementation, rewriting the first question information based on the analysis result may be implemented based on the following steps:

Step B1: replacing, for a knowledge entity in the analysis result, the to-be-processed clue corresponding to the knowledge entity in the first question information.

In an implementation, a one-to-one correspondence between the knowledge entity and the to-be-processed clue in the first question information may be established by traversing the knowledge entities extracted from the analysis result. For a group of successfully matched correspondence, the original to-be-processed clue in the first question information is replaced with the corresponding standardized knowledge entity in the analysis result to complete the standardized rewriting of the to-be-processed clue. The replacement process does not change the sentence structure of the first question information and the logical relationship between the to-be-processed clues, and only performs a concrete modification of the content of the to-be-processed clue.

In addition, the description may be rewritten into a smooth sentence according to the replaced description.

Exemplarily, the first question information is “born in a southern region with developed agriculture”, which can be directly replaced with a knowledge entity “born in XX Province” inferred by the model.

Step B2: retaining, for any to-be-processed clue, the to-be-processed clue unchanged in the first question information in the case where the analysis result of the to-be-processed clue indicates that a corresponding knowledge entity is not able to be extracted.

For any to-be-processed clue in the first question information, if the analysis result clearly indicates that the corresponding knowledge entity is not extracted, that is, the to-be-processed clue has no matching standardized knowledge entity and cannot complete entity replacement, the original expression of the to-be-processed clue is retained in the finally rewritten question information without any modification, deletion or replacement.

For example, the time or space attribute of the target entity in the to-be-processed clue is not given as an absolute value, but is defined as a time or space offset relative to another unknown entity.

For another example, the identity of the target entity is determined by its relative order in a sequence, but the reference point of the sequence itself is unknown.

In the embodiment of the present disclosure, by replacing the corresponding implicit clue in the first question information with an extractable knowledge entity in the analysis result, while keeping the clue from which the knowledge entity cannot be extracted unchanged, it is possible to simply the inference difficulty of the first question information, and retain the core constraint logic and rigor of the clue, so as to finely analyze the cracking process based on the clue dimension and improve the accuracy of difficulty level estimation.

S404: determining the first estimated answer based on the second question information.

In an implementation, the first intelligence agent may determine an optimal result based on the clarified second question information in combination with the inference conclusion of the intermediate conclusion set, and take the optimal result as the final first estimated answer. In a specific implementation, the first intelligence agent may perform association analysis in combination with the full-text context according to the second question information obtained after replacement to obtain the first estimated answer.

S405: generating the cracking result based on the intermediate conclusion set and the first estimated answer.

In an implementation, the first intelligence agent may integrate the intermediate conclusion set with the first estimated answer to form a complete structured result, which is the cracking result.

In the embodiment of the present disclosure, the first intelligence agent in the evaluation large model answers the first question information, forms a structured intermediate conclusion set according to the solution path, rewrites based on the analysis result to obtain clearer second question information, and then obtains the first estimated answer. Finally, the intermediate conclusion and the first estimated answer are integrated to form a cracking result, which can completely restore the whole problem-answering process from clue analysis to answer prediction, and accurately record a key intermediate node and a final estimated result in the problem-answering, providing a comprehensive, real and practical judgment basis for the subsequent second intelligence agent to perform difficulty grading in combination with the truth value of intermediate conclusion and the target answer, thereby improving the accuracy of difficulty level estimation.

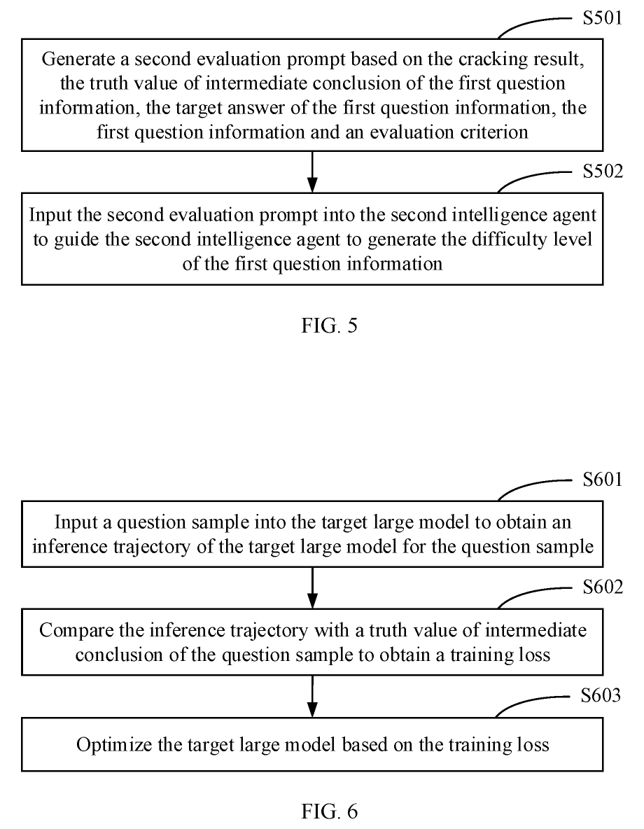

In the embodiment of the present disclosure, Step S302 of inputting the cracking result, the truth value of the intermediate conclusion of the first question information, and the target answer of the first question information into the second intelligence agent of the evaluation large model to obtain the difficulty level of the first question information output from the second intelligence agent, as shown in FIG. 5, includes the following contents:

S501: generating a second evaluation prompt based on the cracking result, the truth value of intermediate conclusion of the first question information, the target answer of the first question information, the first question information and an evaluation criterion.

That is, based on the cracking result of the first question information by the first intelligence agent, in combination with the truth value of intermediate conclusion, the target answer and the original question itself of the first question information, the second evaluation prompt for guiding the second intelligence agent to perform difficulty evaluation is constructed according to a specified evaluation rule.

Herein, the evaluation criterion includes at least one of the following criteria:

(1) Intermediate conclusion inspection criterion, used to evaluate a degree of difference between the intermediate conclusion set and the truth value of intermediate conclusion in the cracking result;

In an implementation, all explicit knowledge entities guessed by the first intelligence agent in the first stage of inference cracking (i.e., the intermediate conclusion set in the cracking result) may be verified one by one through the truth values of intermediate conclusions to judge whether there is misjudgment or missed judgment of the core knowledge entities.

(2) End-point penetration criterion, used to evaluate whether the first estimated answer in the cracking result is consistent with the target answer.

In an implementation, it is judged whether the first estimated answer in the cracking result is consistent with the target answer only when the first estimated answer directly and uniquely hits the target answer. In the case where the first estimated answer is a fuzzy range, not deduced to the final questioning node, and only the intermediate inference node is guessed correctly, it is determined as unpenetrated.

S502: inputting the second evaluation prompt into the second intelligence agent to guide the second intelligence agent to generate the difficulty level of the first question information.

That is, the generated second evaluation prompt is completely input into the second intelligence agent of the evaluation large model, and the prompt guides the second intelligence agent to perform the evaluation operation:

evaluating the degree of difference between the intermediate conclusion set and the truth value of intermediate conclusion in the cracking result, and the higher the degree of difference, the stronger the inductiveness and camouflage of the first question information and the higher the corresponding difficulty level.

In the case where the first estimated answer is a fuzzy range, not deduced to the final questioning node, only the intermediate inference node is guessed correctly, it is determined as unpenetrated, indicating that the corresponding difficulty level of the first question information is higher.

In the embodiment of the present disclosure, based on the inspection criterion of the correctness of intermediate conclusion and the end-point penetration criterion, comprehensive verification is carried out from two core dimensions that are the accuracy of intermediate node in the inference process and the matching degree of final answer, which not only avoids the one-sidedness of single-dimensional grading, but also eliminates the deviation of subjective judgment, making the difficulty grading process of the second intelligence agent more standardized and reproducible and ensuring that the output difficulty level can accurately and truly reflect the actual problem-answering difficulty of the first question information, thereby improving the difficulty of the constructed training sample.

In the embodiment of the present disclosure, the evaluation criterion in the second evaluation prompt may further include a difficulty level grading manner. For example, the difficulty level of correct intermediate conclusion and correct first estimated answer is easy, the difficulty level of partially correct intermediate conclusion and correct first estimated answer is also easy, the difficulty level of partially correct intermediate conclusions and no correct answer is difficult, and so on, multiple difficulty levels can be graded.

For the first question information with a low difficulty level and not suitable as a training sample, the cracking result and the difficulty level evaluation result (which may include evaluation details) may be embedded into the target prompt information, so that the generative large model regenerates the question information with a high difficulty level according to the information in the cracking result.

In the embodiment of the present disclosure, the training and optimization of the target large model may be performed with reference to FIG. 6, including the following contents:

S601: inputting a question sample into the target large model to obtain an inference trajectory of the target large model for the question sample.

The question sample refers to standardized question data used for training, optimizing and difficulty-verifying the target large model, and belongs to difficult data.

The inference trajectory refers to a key path for the target large model to answer the question sample, including searched information, an intermediate conclusion, a conclusion further inferred or searched based on the intermediate conclusion, etc. In an implementation, a batch of question samples may be extracted from the constructed training sample set, and the question samples are input into an initialized target large model one by one. The target large model will independently execute the complete inference process of multiple rounds of search, reading, verification and integration, and simultaneously monitor and record process data such as total inference duration, search call times and intermediate conclusion generation nodes in real time. These complete process data + intermediate conclusion generation nodes are the model inference trajectory.

S602: comparing the inference trajectory with a truth value of intermediate conclusion of the question sample to obtain a training loss.

The truth value of intermediate conclusion may be labeled by a labeling expert, or generated by a large model and manually verified. The generation manner thereof has been described above, and will not be repeated here.

In an implementation, based on the semantic matching ability of the large language model, the inference trajectory of the model may be compared with the truth value of intermediate conclusion to judge whether the inference trajectory of the model covers all key fact points in the truth value of intermediate conclusion. The uncovered fact points and incorrectly matched intermediate conclusions are the core basis for calculating the training loss. The lower the coverage and the more matching errors, the greater the training loss.

S603: optimizing the target large model based on the training loss.

Based on the training loss calculated above, conventional model optimization algorithms such as back propagation and gradient descent are adopted to directionally adjust and iteratively optimize the network parameters, inference logic and clue calling strategy of the target large model.

The iterative training process of Steps S601 to S603 is repeatedly executed until the training loss converges to a preset threshold range and the model inference accuracy meets the standard, so as to complete the training and optimization of the target large model and obtain an optimized target large model with accurate inference ability.

In some embodiments, the question sample may also be input into the target large model to obtain a second estimated answer, and the second estimated answer is compared with a truth value of the answer to obtain a result loss; finally, the training loss and the result loss are fused to obtain a total loss for optimizing the target large model.

In the embodiment of the present disclosure, by comparing the inference trajectory with the truth value of intermediate conclusion, the deviation and vulnerability of the model in links such as clue analysis and node inference can be accurately located, so that the training loss can truly reflect the shortcoming of the model’s deep inference ability. Then the model parameter is optimized in a targeted manner based on the loss, guiding the model to gradually develop a standardized inference path conforming to the truth value, effectively correcting problems such as shortcut inference and wrong association when the model answers questions, and finally realizing the essential improvement of the model’s deep search inference ability.

In the embodiment of the present disclosure, the question sample is derived from a sample set, the sample set includes the first question information and/or third question information, and the third question information is constructed based on benchmark knowledge.

The benchmark knowledge is a principled and underlying rule system formed by summarizing, refining and standardizing a large amount of difficult data through statistical analysis, combined with the deep inference training requirement of large model, high-quality difficult question construction logic and model ability evaluation standard, and has the characteristics of structuralization, dimensionalization, reusability and popularization.

It should be noted that the expert knowledge as described above is formed and applied on the basis of the principles, frameworks and standards specified by the benchmark knowledge, taking the benchmark knowledge as the generation basis and execution basis.

In the embodiment of the present disclosure, the question sample simultaneously includes the automatically generated first question information, so as to continuously generate the training samples to form a closed loop of difficult sample generation and model training optimization, thereby continuously iterating and improving the target large model. The third question information is constructed based on the benchmark knowledge which, as high-quality difficult data, can help the target large model learn high-quality knowledge content and improve the information processing ability of the target large model.

In the embodiment of the present disclosure, the benchmark knowledge may include at least one of the following:

(1) Task type dimension, used to require that question-answering needs to adopt a search capability with a complexity higher than a preset complexity threshold;

In an implementation, core search capabilities such as cross-domain retrieval, multi-hop inference, real-time information verification and long text integration may be adopted, and low-complexity task types such as single retrieval and simple question answering are abandoned, thereby ensuring that the question-answering requires the search capability with a complexity higher than the preset complexity threshold.

(2) Structural strength dimension, used to require that the inference difficulty of the question-answering is higher than a preset difficulty;

That is, the question-answering cannot be answered by relying on single-step semantic understanding, direct information matching or shallow logical inference.

In an implementation, the inference difficulty may be measured from indicators such as the length of the inference chain, the number of independent logic chains, and the number of constraint conditions.

Exemplarily, the longest inference chain for answering the question is required to be more than or equal to (≥) 5 steps, the number of independent logic chains more than or equal to (≥) 4, and the number of constraint conditions more than or equal to (≥) 8, so as to require that the inference difficulty of answering the question is higher than the preset difficulty, and eliminate low-difficulty and shallow inference.

(3) Topological structure dimension, used to require that the inference path for answering the question depends on a plurality of intermediate conclusions with cross-dependency relationships therebetween, and that different answer clues can independently constrain the answering range;

The cross-dependency relationship between intermediate conclusions means that the plurality of intermediate conclusions involved in the inference process are not unidirectional linear derivation, but are interrelated and mutually inference premises. A single intermediate conclusion cannot independently support the final answer derivation, and the problem-answering process can be promoted only by combining cross-verification and complementary derivation of the plurality of intermediate conclusions, eliminating single-chain simple inference.

Independent constraint of the answering range means that the answer clues delimit respective corresponding candidate answering ranges, there is an overlapping intersection between the answering ranges corresponding to different answer clues, but there is no inclusion relationship that one range completely contains another range. The unique target answer can be finally locked only by combining the range overlapping areas of the plurality of clues, avoiding the direct locking of the answer by a single clue or the redundant overlapping of the constraint ranges between the clues.

(4) Condition quality dimension, used to constrain that the answer clues of the question are expressed in a fuzzy manner;

That is, the answer clues are not expressed in concrete, straightforward and highly directional sentences, but the key information is presented in implicit description, indirect expression and semantic implication, which will not directly correspond to knowledge entities or answer keywords. The target large model needs to first perform in-depth analysis such as semantic disassembly, knowledge mapping and ambiguity resolution on the clues to extract effective inference information, avoiding the model from directly giving conclusions by relying on shallow semantic matching.

In an implementation, explicit keywords that can directly locate the answer may be removed, and niche information that is not widely known but objectively accurate is preferentially selected as the question condition, so as to avoid the possibility that the model directly searches for the answer through keywords.

(5) Answer form dimension, used to constrain that the answer is verifiable and unchanged within a specified duration.

The constrained answer is verifiable, that is, there is an objective, unique and verifiable standard answer, which can be judged right or wrong through authoritative data sources and truth sets, facilitating model training loss calculation and effect evaluation.

No change occurs within the specified duration, that is, the answer content will not change, no ambiguity or update occurs within the specified duration, avoiding invalid training samples and distorted evaluation results caused by answer failure, and ensuring the reliability of the training and evaluation process.

In an implementation, an unpopular and niche object may be preferentially selected as an answer, avoiding high-frequency content in the model pre-training corpus, preventing the model from directly answering by virtue of internalized memory, and ensuring the uniqueness, stability and verifiability of the answer.

In the embodiment of the present disclosure, by standardizing and constraining the benchmark knowledge from multiple dimensions of task type, structural strength, topological structure, condition quality and answer form, it can be ensured that the constructed third question information has sufficient inference complexity, stable logical structure, fuzzy clue expression, verifiable and unchangeable answer, and can provide high-quality and high-difficulty benchmark training sample for the target large model.

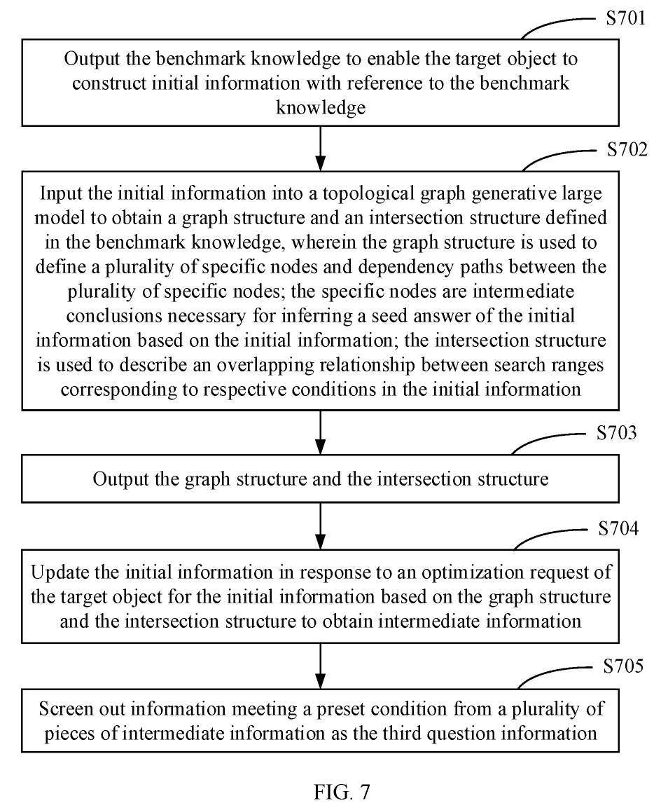

In the embodiment of the present disclosure, constructing the third question information, as shown in FIG. 7, includes the following contents:

S701: outputting the benchmark knowledge to enable the target object to construct initial information with reference to the benchmark knowledge.

The target object is a labeling person responsible for constructing data.

In an implementation, the target object may refer to the output benchmark knowledge and adopt a reverse generation path: taking the target answer entity as a starting point, reversely deducing and constructing initial information. The initial information may only include the target answer and initial constraint conditions.

S702: inputting the initial information into a topological graph generative large model to obtain a graph structure and an intersection structure defined in the benchmark knowledge, wherein the graph structure is used to define a plurality of specific nodes and dependency paths between the plurality of specific nodes; the specific nodes are intermediate conclusions necessary for inferring a seed answer of the initial information based on the initial information; the intersection structure is used to describe an overlapping relationship between search ranges corresponding to respective conditions in the initial information.

In an implementation, the topological graph generative large model may extract core intermediate conclusions necessary for inferring the target answer of the initial information based on the logical chain of the initial information, and define them as specific nodes; meanwhile, sort out the sequential derivation relationship and dependency association relationship between the specific nodes, generate a clear dependency path, and finally form a complete graph structure.

The topological graph generative large model disassembles various constraint conditions, retrieval dimensions and limited ranges contained in the initial information, analyzes independent search ranges corresponding to the conditions, further digs an overlapping area, an inclusion relationship and a mutual exclusion relationship between the ranges, and generates an intersection structure through a quantitative indicator and a logical description.

S703: outputting the graph structure and the intersection structure.

That is, the graph structure and intersection structure output by the topological graph generative large model are visually rendered.

In an implementation, by intuitively presenting in the form of a topological schematic diagram, a logical relationship table, a range intersection map, etc., core prompt information such as key nodes, dependency path breakpoints, and intersection conflict areas are synchronously marked and pushed to the target object.

The target object studies and judges the logic, integrity and rationality of the initial information in combination with the visual structure data, and initiates an initial information optimization request to the system for problems such as missing nodes, disordered paths, abnormal range overlap and redundant conditions. The optimization request includes detailed information such as specific modification directions, content adjustment schemes and logical correction opinions.

S704: updating the initial information in response to an optimization request of the target object for the initial information based on the graph structure and the intersection structure to obtain intermediate information.

In an implementation, after receiving the optimization request initiated by the target object, the legitimacy and rationality of the request content are verified, and the initial information is updated according to the optimization scheme after the verification is passed. For example, it may supplement an inference link for a missing specific node, sort out a disordered dependency path, remove a redundant constraint condition, correct a conflicting range intersection, and improve a fuzzy inference clue.

Each time an optimization update is completed, a corresponding piece of intermediate information is generated; for the same initial information, the target object can be supported to initiate multiple rounds of optimization to generate multiple pieces of differentiated intermediate information, forming an intermediate information set, providing multiple alternative data for subsequent screening.

S705: screening out information meeting a preset condition from a plurality of pieces of intermediate information as the third question information.

Herein, the preset condition is determined based on an inference load and/or a cross-model inference difficulty. That is, the intermediate information with a large inference load and a large cross-model inference difficulty is screened out as the third question information.

In the embodiment of the present disclosure, the target object is guided to standardly construct initial information through benchmark knowledge, and the inference logic is converted into a clear graph structure and intersection structure by means of a topological graph generative large model, so as to clarify the intermediate conclusion required for inference, the dependency path and the overlapping relationship between conditions. Then the initial information is iteratively optimized and screened based on the above structured information, so as to generate third question information with rigorous logic, clear inference chain and controllable difficulty and conforming to high-quality evaluation and training standard, providing reliable and high-quality benchmark sample support for the stable improvement of the overall model ability and effect evaluation.

In the embodiment of the present disclosure, screening out the information meeting the preset condition from the plurality of pieces of intermediate information as the third question information includes:

Step C1: inputting, for a piece of intermediate information, the intermediate information into a first verification large model to obtain the inference load of the first verification large model;

In an implementation, the intermediate information may be input into the first verification large model, and the first verification large model independently executes the complete inference process of multiple rounds of search, reading, verification and integration. Meanwhile, the inference load of the first verification large model is determined by real-time monitoring and recording process data such as total inference duration, search call times and intermediate conclusion generation nodes.

Herein, the longer the inference time, the more search call times, and the fewer intermediate conclusion generation nodes, the greater the inference load of the first verification large model.

Step C2: answering the intermediate information by using a second verification large model without using a search function to obtain a first inference result in the case where the inference load of the intermediate information meets a preset load requirement;

After confirming that the inference load meets the standard, the intermediate information is input into the second verification large model, and the second verification large model independently completes the understanding, inference and answering process under the condition of disabling external search and only relying on its own pre-trained knowledge, and finally outputs the corresponding answer as the first inference result.

In some embodiments, only the first verification large model or the second verification large model may be used to complete the screening, that is, the same verification large model is used to verify the intermediate information, so as to determine the corresponding inference load and obtain the first inference result.

Step C3: answering the intermediate information by using a plurality of third verification large models with using the search function to obtain a plurality of second inference results in the case where the first inference result is a correct result;

On the premise that the first inference result is confirmed to be correct, the same intermediate information is input into a plurality of third verification large models with different architectures, respectively. The third verification large models independently complete the complete process of information retrieval, content screening, logical inference and answer generation under the condition of open search permission and normal call of search tools, and the model outputs a corresponding answer as the second inference result.

Herein, the plurality of third verification large models perform inference and search independently of each other without interference, which can fully reflect the cracking difficulty and solution effect of different models on the same intermediate information when having retrieval capabilities. The plurality of second inference results include inference results obtained by answering the intermediate information and inference results corresponding to an excessive inference load.

Step C4: determining the intermediate information as the third question information in the case where at least two second inference results indicate that the inference difficulty of the intermediate information meets a difficulty requirement.

Herein, the difficulty requirement is determined if any one of the following conditions is met:

Condition 1: Inference timeout;

Condition 2: No correct inference result is obtained.

In an implementation, the plurality of second inference results are compared with the standard answer one by one to judge whether the result is correct, and the number of third verification large models with wrong answers is counted. When the second inference results of at least two third verification large models are incorrect, it is determined that the intermediate information has sufficient difficulty and meets the high-quality question screening standard, so as to determine it as the final third question information.

Herein, the more models with search capabilities that cannot answer correctly, the more difficult the intermediate information is to be cracked by conventional retrieval and inference, and the more suitable it is to be used as a highly challenging and long-effect evaluation question.

In the embodiment of the present disclosure, the intermediate information is screened sequentially by multi-level verification large models. First, the first verification large model evaluates the inference load of the intermediate information to ensure that it has sufficient inference difficulty. Then, the second verification large model verifies that the information can obtain a correct answer only relying on internal knowledge in a search-free environment to ensure the rationality of the inference logic. Finally, cross-verification is performed by the plurality of third verification large models with search functions to ensure that the intermediate information cannot be directly cracked by simple search, thereby screening out the third question information with high inference strength, high retrieval difficulty, and stable and reliable quality, and providing high-standard and high-difficulty benchmark samples for the training and evaluation of the target large model.

In summary, the solution according to the embodiments of the present disclosure has the following advantages: first, in terms of the construction mechanism, it is transformed from completely open free design to quantitative construction under a framework constraint, solving the problem of uncontrollable difficulty and question form; second, in terms of the verification manner, it is transformed from manual subjective testing to verification based on model capabilities, improving efficiency and unifying standards, and significantly reducing labor cost and subjective factor. Overall, the solution according to the present disclosure can transform construction of a search question with fuzzy standard from relying on individual expert experience into a scalable, reproducible and optimizable standardized process, providing a complete solution for the construction of high-quality and large-scale data set.

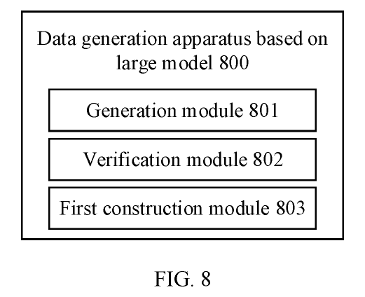

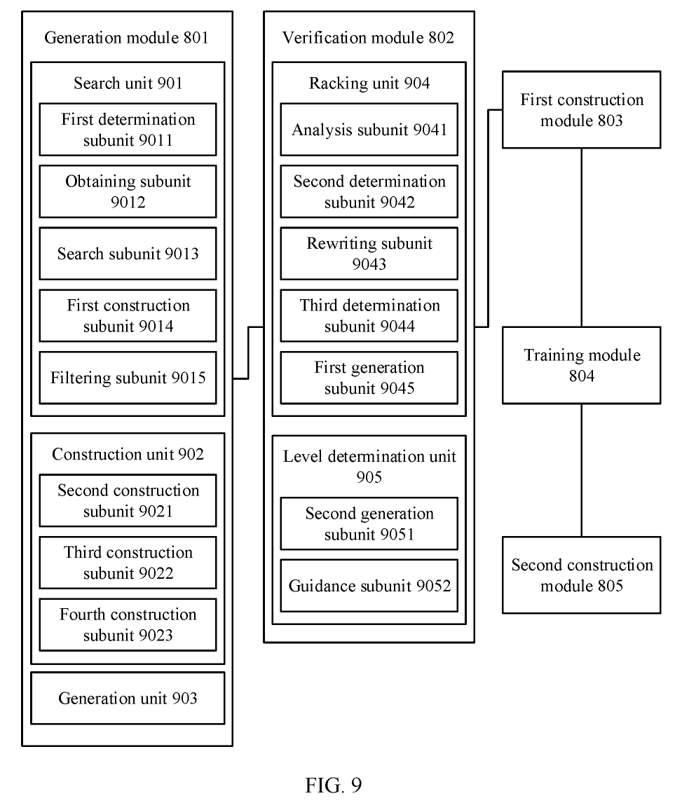

Based on the same technical concept, an embodiment of the present disclosure further provides an apparatus 800 for generating data based on a large model, as shown in FIG. 8, including:

a generation module 801, configured to input target prompt information into a generative large model, such that the generative large model generates first question information based on expert knowledge and a target action sequence in the target prompt information, wherein the target action sequence is configured to constrain an execution path of the generative large model; the first question information includes text data, and the text data is a clue required for answering the first question information;

a verification module 802, configured to verify the first question information based on an evaluation large model to obtain a difficulty level, wherein the difficulty level is used to represent a degree of difficulty for the target large model to answer the first question information; and

a first construction module 803, configured to construct a training sample for the target large model based on the first question information in the case where the difficulty level is a target level.

In some embodiments, as shown in FIG. 9, the generation module 801 includes:

a search unit 901, configured to search for a plurality of distractors having a preset association relationship with a target answer with reference to a first action requirement in the target action sequence;

a construction unit 902, configured to construct an answer clue set meeting a target requirement with reference to a second action requirement in the target action sequence, based on the expert knowledge and multi-dimensional association information between the target answer and the plurality of distractors;

a generation unit 903, configured to generate the first question information based on the answer clue set.

In some embodiments, the search unit 901 includes:

a first determination subunit 9011, configured to determine a target field to which the target answer belongs;

an obtaining subunit 9012, configured to obtain entity information associated with the target answer based on the preset association relationship corresponding to the target field;

a search subunit 9013, configured to search for a plurality of similar entities whose similarity with the entity information meets a similarity requirement to obtain a plurality of candidate items;

a first construction subunit 9014, configured to construct a general reference clue for the plurality of candidate items and the target answer; and

a filtering subunit 9015, configured to filter out candidate items that distinguish the target answer from the candidate items by relying on at most a preset number of reference clues, and taking the remaining candidate items as distractors.

In some embodiments, the target requirement in the expert knowledge includes a requirement for a relative differential clue and a direct clue; the construction unit 902 includes:

a second construction subunit 9021, configured to construct the relative differential clue between the target answer and at least one of the plurality of distractors based on same category information to which the target answer and the plurality of distractors belong, the relative differential clue being used to represent a relative relationship between the target answer and the at least one distractor with respect to the same category information;

a third construction subunit 9022, configured to construct the direct clue based on the target answer, the direct clue being used to describe an attribute of the target answer, the direct clue being expressed in a fuzzy expression and meeting a constraint condition; the constraint condition being used to prevent a single direct clue from reducing a search range of the answer by a preset degree; and

a fourth construction subunit 9023, configured to construct the answer clue set based on the relative differential clue and the direct clue.

In some embodiments, the target requirement further includes that the number of the relative differential clues is higher than that of the direct clues, and a proportion of the relative differential clues in the answer clue set is higher than a preset proportion.

In some embodiments, the verification module 802 includes:

a cracking unit 904, configured to crack the first question information based on a first intelligence agent in the evaluation large model to obtain a cracking result, the cracking result including an intermediate conclusion set obtained by inference analysis on the first question information and a first estimated answer; and

a level determination unit 905, configured to input the cracking result, a truth value of the intermediate conclusion of the first question information, and the target answer of the first question information into a second intelligence agent of the evaluation large model to obtain the difficulty level of the first question information output from the second intelligence agent.

In some embodiments, the cracking unit 904 includes:

an analysis subunit 9041, configured to perform the inference analysis on a plurality of to-be-processed clues described implicitly in the first question information based on the first intelligence agent to obtain an analysis result;

a second determination subunit 9042, configured to determine the intermediate conclusion set based on the analysis result of the plurality of to-be-processed clues;

a rewriting subunit 9043, configured to rewrite the first question information based on the analysis result to obtain second question information;

a third determination subunit 9044, configured to determine the first estimated answer based on the second question information;

a first generation subunit 9045, configured to generate the cracking result based on the intermediate conclusion set and the first estimated answer.

In some embodiments, the analysis subunit 9041 is specifically configured to:

input a first evaluation prompt into the first intelligence agent, so that the first intelligence agent performs the inference analysis on the plurality of to-be-processed clues in the first question information with reference to at least one of the following constraint conditions in the first evaluation prompt to obtain the analysis result:

Constraint Condition 1: performing knowledge inference on a single to-be-processed clue based on the first intelligence agent to determine a knowledge entity corresponding to the single to-be-processed clue;

Constraint condition 2: performing knowledge inference based on context information in the first question information to obtain a knowledge entity inferred from the plurality of to-be-processed clues; or

Constraint condition 3: retaining at least one to-be-processed clue unchanged in the case where the at least one to-be-processed clue meets a preset feature, the preset feature being used to represent that the at least one to-be-processed clue is not able to be cracked.

In some embodiments, the rewriting subunit 9043 is specifically configured to:

replace, for a knowledge entity in the analysis result, the to-be-processed clue corresponding to the knowledge entity in the first question information; and

retain, for any to-be-processed clue, the to-be-processed clue unchanged in the first question information in the case where the analysis result of the to-be-processed clue indicates that a corresponding knowledge entity is not able to be extracted.

In some embodiments, the second determination subunit 9042 is specifically configured to:

take the knowledge entity obtained by the inference analysis as an intermediate conclusion to construct the intermediate conclusion set.

In some embodiments, the level determination unit 905 includes:

a second generation subunit 9051, configured to generate a second evaluation prompt based on the cracking result, the truth value of intermediate conclusion of the first question information, the target answer of the first question information, the first question information and an evaluation criterion;

a guidance subunit 9052, configured to input the second evaluation prompt into the second intelligence agent to guide the second intelligence agent to generate the difficulty level of the first question information;

wherein the evaluation criterion includes at least one of the following criteria:

an intermediate conclusion inspection criterion, used to evaluate a degree of difference between the intermediate conclusion set and the truth value of intermediate conclusion in the cracking result; and

an end-point penetration criterion, used to evaluate whether the first estimated answer in the cracking result is consistent with the target answer.

In some embodiments, the apparatus further includes a training module 804, configured to train the target large model based on the following manner:

inputting a question sample into the target large model to obtain an inference trajectory of the target large model for the question sample;

comparing the inference trajectory with a truth value of intermediate conclusion of the question sample to obtain a training loss; and

optimizing the target large model based on the training loss.

In some embodiments, the question sample is derived from a sample set, the sample set includes the first question information and/or third question information, and the third question information is constructed based on benchmark knowledge.

In some embodiments, the apparatus further includes a second construction module 805, configured to construct the third question information based on the following manner:

outputting the benchmark knowledge to enable the target object to construct initial information with reference to the benchmark knowledge;

inputting the initial information into a topological graph generative large model to obtain a graph structure and an intersection structure defined in the benchmark knowledge, wherein the graph structure is used to define a plurality of specific nodes and dependency paths between the plurality of specific nodes; the specific nodes are intermediate conclusions necessary for inferring a seed answer of the initial information based on the initial information; the intersection structure is used to describe an overlapping relationship between search ranges corresponding to respective conditions in the initial information;

outputting the graph structure and the intersection structure;

updating the initial information in response to an optimization request of the target object for the initial information based on the graph structure and the intersection structure to obtain intermediate information; and

screening out information meeting a preset condition from a plurality of pieces of intermediate information as the third question information, wherein the preset condition is determined based on an inference load and/or a cross-model inference difficulty.

In some embodiments, the second construction module 805 is specifically configured to:

input, for a piece of intermediate information, the intermediate information into a first verification large model to obtain the inference load of the first verification large model;

answer the intermediate information by using a second verification large model without using a search function to obtain a first inference result in the case where the inference load of the intermediate information meets a preset load requirement;

answer the intermediate information by using a plurality of third verification large models with using the search function to obtain a plurality of second inference results in the case where the first inference result is a correct result; and

determine the intermediate information as the third question information in the case where at least two second inference results indicate that the inference difficulty of the intermediate information meets a difficulty requirement.

In some embodiments, the benchmark knowledge includes at least one of:

a task type dimension, used to require that question-answering needs to adopt a search capability with a complexity higher than a preset complexity threshold;

a structural strength dimension, used to require that the inference difficulty of the question-answering is higher than a preset difficulty;

a topological structure dimension, used to require that the inference path for answering the question depends on a plurality of intermediate conclusions with cross-dependency relationships therebetween, and that different answer clues can independently constrain the answering range;

a condition quality dimension, used to constrain that the answer clues of the question are expressed in a fuzzy manner; or

an answer form dimension, used to constrain that the answer is verifiable and unchanged within a specified duration.

In some embodiments, the expert knowledge further includes:

a target answer of the generated first question information is unique, and at least one clue in the first question information is a verifiable fact.

For the specific functions and example descriptions of each module and sub-module of the apparatus in embodiments of the present disclosure, reference may be made to the relevant descriptions of corresponding steps in the above method embodiments, and details thereof are not described herein again.

In the technical solution of the present disclosure, the collection, storage and application of any type of information such as user personal information involved comply with the provisions of relevant laws and regulations and do not violate public order and good customs.

According to embodiments of the present disclosure, the present disclosure also provides an electronic device, a readable storage medium and a computer program product.

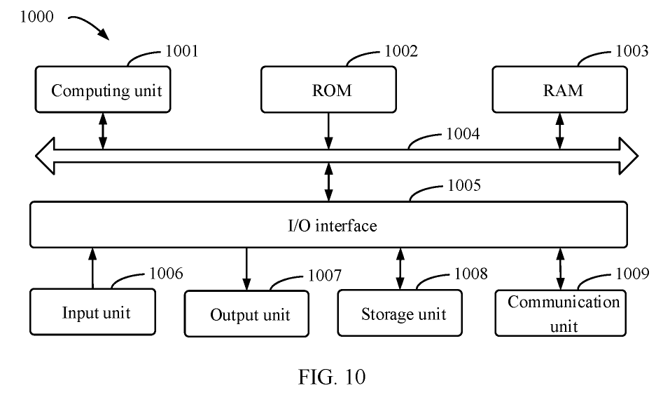

FIG. 10 shows a schematic block diagram of an exemplary electronic device 1000 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar electronic devices. The components shown herein, their connections and relationships, and their functions are merely examples, and are not intended to limit the implementation of the present disclosure described and/or required herein.

As shown in FIG. 10, the electronic device 1000 includes a computing unit 1001 that may perform various appropriate actions and processes according to a computer program stored in a Read-Only Memory (ROM) 1002 or a computer program loaded from a storage unit 1008 into a Random Access Memory (RAM) 1003. Various programs and data required for an operation of device 1000 may also be stored in the RAM 1003. The computing unit 1001, the ROM 1002 and the RAM 1003 are connected to each other through a bus 1004. The input/output (I/O) interface 1005 is also connected to the bus 1004.

A plurality of components in the electronic device 1000 are connected to the I/O interface 1005, and include an input unit 1006 such as a keyboard, a mouse, or the like; an output unit 1007 such as various types of displays, speakers, or the like; the storage unit 1008 such as a magnetic disk, an optical disk, or the like; and a communication unit 1009 such as a network card, a modem, a wireless communication transceiver, or the like. The communication unit 1009 allows the electronic device 1000 to exchange information/data with other devices through a computer network such as the Internet and/or various telecommunication networks.

The computing unit 1001 may be various general-purpose and/or special-purpose processing components with processing and computing capabilities. Some examples of the computing unit 1001 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1001 performs various methods and processing described above, such as the above the method for generating data based on large model. For example, in some implementations, the above method for generating data based on large model may be implemented as a computer software program tangibly contained in a computer-readable medium, such as the storage unit 1008. In some implementations, a part or all of the computer program may be loaded and/or installed on the device 1000 via the ROM 1002 and/or the communication unit 1009. When the computer program is loaded into RAM 1003 and executed by the computing unit 1001, one or more steps of the method for generating data based on large model described above may be performed. Alternatively, in other implementations, the computing unit 1001 may be configured to perform the above method for generating data based on large model by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM) or a flash memory, an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for generating data based on large model, comprising:
inputting target prompt information into a generative large model, such that the generative large model generates first question information based on expert knowledge and a target action sequence in the target prompt information, wherein the target action sequence is configured to constrain an execution path of the generative large model; the first question information includes text data, and the text data is a clue required for answering the first question information;
verifying the first question information based on an evaluation large model to obtain a difficulty level, wherein the difficulty level is used to represent a degree of difficulty for the target large model to answer the first question information; and
constructing a training sample for the target large model based on the first question information in the case where the difficulty level is a target level.

2. The method of claim 1, wherein the inputting of the target prompt information into the generative large model, such that the generative large model generates the first question information based on the expert knowledge and the target action sequence in the target prompt information, comprises:
triggering, under the guidance of the target action sequence of the target prompt information, the generative large model to perform operations of:
searching for a plurality of distractors having a preset association relationship with a target answer with reference to a first action requirement in the target action sequence;
constructing an answer clue set meeting a target requirement with reference to a second action requirement in the target action sequence, based on the expert knowledge and multi-dimensional association information between the target answer and the plurality of distractors; and
generating the first question information based on the answer clue set.

3. The method of claim 2, wherein the searching for the plurality of distractors having the preset association relationship with the target answer comprises:
determining a target field to which the target answer belongs;
obtaining entity information associated with the target answer based on the preset association relationship corresponding to the target field;
searching for a plurality of similar entities whose similarity with the entity information meets a similarity requirement to obtain a plurality of candidate items;
constructing a general reference clue for the plurality of candidate items and the target answer; and
filtering out candidate items that distinguish the target answer from the candidate items by relying on at most a preset number of reference clues, and taking the remaining candidate items as distractors.

4. The method of claim 2, wherein the target requirement in the expert knowledge comprises requirements for a relative differential clue and a direct clue; the constructing of the answer clue set meeting the target requirement based on the expert knowledge and the multi-dimensional association information between the target answer and the plurality of distractors, comprises:
constructing the relative differential clue between the target answer and at least one of the plurality of distractors based on same category information to which the target answer and the plurality of distractors belong, the relative differential clue being used to represent a relative relationship between the target answer and the at least one distractor with respect to the same category information;
constructing the direct clue based on the target answer, the direct clue being used to describe an attribute of the target answer, the direct clue being expressed in a fuzzy expression and meeting a constraint condition; the constraint condition being used to prevent a single direct clue from reducing a search range of the answer by a preset degree; and
constructing the answer clue set based on the relative differential clue and the direct clue.

5. The method of claim 4, wherein the target requirement further comprises that the number of the relative differential clues is higher than that of the direct clues, and a proportion of the relative differential clues in the answer clue set is higher than a preset proportion.

6. The method of claim 1, wherein the verifying of the first question information based on the evaluation large model to obtain the difficulty level comprises:
cracking the first question information based on a first intelligence agent in the evaluation large model to obtain a cracking result, the cracking result including an intermediate conclusion set obtained by inference analysis on the first question information and a first estimated answer; and
inputting the cracking result, a truth value of the intermediate conclusion of the first question information, and the target answer of the first question information into a second intelligence agent of the evaluation large model to obtain the difficulty level of the first question information output from the second intelligence agent.

7. The method of claim 6, wherein the cracking of the first question information based on the first intelligence agent in the evaluation large model to obtain the cracking result comprises:
performing the inference analysis on a plurality of to-be-processed clues described implicitly in the first question information based on the first intelligence agent to obtain an analysis result;
determining the intermediate conclusion set based on the analysis result of the plurality of to-be-processed clues;
rewriting the first question information based on the analysis result to obtain second question information;
determining the first estimated answer based on the second question information; and
generating the cracking result based on the intermediate conclusion set and the first estimated answer.

8. The method of claim 7, wherein the performing of the inference analysis on the plurality of to-be-processed clues described implicitly in the first question information based on the first intelligence agent to obtain the analysis result comprises:
inputting a first evaluation prompt into the first intelligence agent, so that the first intelligence agent performs the inference analysis on the plurality of to-be-processed clues in the first question information with reference to at least one of the following constraint conditions in the first evaluation prompt to obtain the analysis result:
Constraint Condition 1: performing knowledge inference on a single to-be-processed clue based on the first intelligence agent to determine a knowledge entity corresponding to the single to-be-processed clue;
Constraint Condition 2: performing knowledge inference based on context information in the first question information to obtain a knowledge entity inferred from the plurality of to-be-processed clues; or
Constraint Condition 3: retaining at least one to-be-processed clue unchanged in the case where the at least one to-be-processed clue meets a preset feature, the preset feature being used to represent that the at least one to-be-processed clue is not able to be cracked.

9. The method of claim 7, wherein the rewriting of the first question information based on the analysis result comprises:
replacing, for a knowledge entity in the analysis result, the to-be-processed clue corresponding to the knowledge entity in the first question information; and
retaining, for any to-be-processed clue, the to-be-processed clue unchanged in the first question information in the case where the analysis result of the to-be-processed clue indicates that a corresponding knowledge entity is not able to be extracted.

10. The method of claim 7, wherein the determining of the intermediate conclusion set based on the analysis result of the plurality of to-be-processed clues comprises:
taking the knowledge entity obtained by the inference analysis as an intermediate conclusion to construct the intermediate conclusion set.

11. The method of claim 6, wherein the inputting of the cracking result, the truth value of the intermediate conclusion of the first question information, and the target answer of the first question information into the second intelligence agent of the evaluation large model to obtain the difficulty level of the first question information output from the second intelligence agent comprises:
generating a second evaluation prompt based on the cracking result, the truth value of intermediate conclusion of the first question information, the target answer of the first question information, the first question information and an evaluation criterion; and
inputting the second evaluation prompt into the second intelligence agent to guide the second intelligence agent to generate the difficulty level of the first question information,
wherein the evaluation criterion includes at least one of:
an intermediate conclusion inspection criterion, used to evaluate a degree of difference between the intermediate conclusion set and the truth value of intermediate conclusion in the cracking result; or
an end-point penetration criterion, used to evaluate whether the first estimated answer in the cracking result is consistent with the target answer.

12. The method of claim 1, further comprising training the target large model based on the following manner:
inputting a question sample into the target large model to obtain an inference trajectory of the target large model for the question sample;
comparing the inference trajectory with a truth value of intermediate conclusion of the question sample to obtain a training loss; and
optimizing the target large model based on the training loss.

13. The method of claim 12, wherein the question sample is derived from a sample set, the sample set comprises the first question information and/or third question information, and the third question information is constructed based on benchmark knowledge.

14. The method of claim 13, further comprising constructing the third question information based on the following manner:
outputting the benchmark knowledge to enable the target object to construct initial information with reference to the benchmark knowledge;
inputting the initial information into a topological graph generative large model to obtain a graph structure and an intersection structure defined in the benchmark knowledge, wherein the graph structure is used to define a plurality of specific nodes and dependency paths between the plurality of specific nodes; the specific nodes are intermediate conclusions necessary for inferring a seed answer of the initial information based on the initial information; the intersection structure is used to describe an overlapping relationship between search ranges corresponding to respective conditions in the initial information;
outputting the graph structure and the intersection structure;
updating the initial information in response to an optimization request of the target object for the initial information based on the graph structure and the intersection structure to obtain intermediate information; and
screening out information meeting a preset condition from a plurality of pieces of intermediate information as the third question information, wherein the preset condition is determined based on an inference load and/or a cross-model inference difficulty.

15. The method of claim 14, wherein the screening out the information meeting the preset condition from the plurality of pieces of intermediate information as the third question information comprises:
inputting, for a piece of intermediate information, the intermediate information into a first verification large model to obtain the inference load of the first verification large model;
answering the intermediate information by using a second verification large model without using a search function to obtain a first inference result in the case where the inference load of the intermediate information meets a preset load requirement;
answering the intermediate information by using a plurality of third verification large models with using the search function to obtain a plurality of second inference results in the case where the first inference result is a correct result; and
determining the intermediate information as the third question information in the case where at least two second inference results indicate that the inference difficulty of the intermediate information meets a difficulty requirement.

16. The method of claim 13, wherein the benchmark knowledge comprises at least one of:
a task type dimension, used to require that question-answering needs to adopt a search capability with a complexity higher than a preset complexity threshold;
a structural strength dimension, used to require that the inference difficulty of the question-answering is higher than a preset difficulty;
a topological structure dimension, used to require that the inference path for answering the question depends on a plurality of intermediate conclusions with cross-dependency relationships between the intermediate conclusions, and that different answer clues are able to independently constrain the answering range;
a condition quality dimension, used to constrain that the answer clues of the question are expressed in a fuzzy manner; or
an answer form dimension, used to constrain that the answer is verifiable and unchanged within a specified duration.

17. The method of claim 1, wherein the expert knowledge further comprises:
a target answer of the generated first question information is unique, and at least one clue in the first question information is a verifiable fact.

18. An electronic device, comprising:
at least one processor; and
a memory connected in communication with the at least one processor;
wherein the memory stores an instruction executable by the at least one processor, and the instruction, when executed by the at least one processor, enables the at least one processor to execute:
inputting target prompt information into a generative large model, such that the generative large model generates first question information based on expert knowledge and a target action sequence in the target prompt information, wherein the target action sequence is configured to constrain an execution path of the generative large model; the first question information includes text data, and the text data is a clue required for answering the first question information;
verifying the first question information based on an evaluation large model to obtain a difficulty level, wherein the difficulty level is used to represent a degree of difficulty for the target large model to answer the first question information; and
constructing a training sample for the target large model based on the first question information in the case where the difficulty level is a target level.

19. The electronic device of claim 18, wherein the instruction, when executed by the at least one processor, enables the at least one processor to execute the inputting of the target prompt information into the generative large model, such that the generative large model generates the first question information based on the expert knowledge and the target action sequence in the target prompt information, by:
triggering, under the guidance of the target action sequence of the target prompt information, the generative large model to perform operations of:
searching for a plurality of distractors having a preset association relationship with a target answer with reference to a first action requirement in the target action sequence;
constructing an answer clue set meeting a target requirement with reference to a second action requirement in the target action sequence, based on the expert knowledge and multi-dimensional association information between the target answer and the plurality of distractors; and
generating the first question information based on the answer clue set.

20. A non-transitory computer-readable storage medium storing a computer instruction thereon, wherein the computer instruction is used to cause a computer to execute:
inputting target prompt information into a generative large model, such that the generative large model generates first question information based on expert knowledge and a target action sequence in the target prompt information, wherein the target action sequence is configured to constrain an execution path of the generative large model; the first question information includes text data, and the text data is a clue required for answering the first question information;
verifying the first question information based on an evaluation large model to obtain a difficulty level, wherein the difficulty level is used to represent a degree of difficulty for the target large model to answer the first question information; and
constructing a training sample for the target large model based on the first question information in the case where the difficulty level is a target level.
